(19) United States
(12) Patent Application Publication
(10) Pub. No.: US 2012/0283984 A1
(43) Pub. Date: Nov. 8, 2012

(54) AUTOMATIC CONTROL METHOD OF INFLATION

(75) Inventor: KUO-HUAN PENG, KAOHSIUNG CITY (TW)

(73) Assignee: TAIWAN SILICON MICROELECTRONICS CO., LTD., KAOHSIUNG CITY (TW)

(21) Appl. No.: 13/102,246

(22) Filed: May 6, 2011

(51) Int. Cl. B60C 23/02

(52) U.S. Cl. 702/138

(57) ABSTRACT

An automatic control method of inflation is revealed. An inflator including a pressure gauge with a microprocessor automatically controls an inflated object to be inflated until the pressure reaches an initial set pressure value on the pressure gauge. After the pressure reaching the initial set pressure value, an air pump of the inflator is shut down until the pressure gets balanced. Now the value shown on the pressure gauge is lower than the initial set pressure value. The difference between an actual pressure value and the initial set pressure value is calculated and is added with the initial set pressure value to get a new set pressure value the inflated object actually needs by the microprocessor. Now the inflator starts inflation again until the pressure reaches the new set pressure value. The inflation is completely precisely.

### BACKGROUND OF THE INVENTION

1. Field of the Invention

The present invention relates to a method of inflation, especially to an automatic control method of inflation that inflates inflated objects to a set pressure value easily and precisely.

2.Description of Related Art

Take a tire inflator as an example. As the air pressure in a tire decreases, its friction with the road increases and more power is required to drive the vehicle. Under-inflation can damage the tire, create wear and reduce the life of the tire. Thus inflators such as tire pumps or air compressors are required to increase the air pressure in the tire when the tire pressure drops to a low level and the tire becomes flat. The inflated tires keep the vehicle running smoothly.

An inflator generally includes an air pump connected to one end of an inflator hose while the other end of the inflator hose is assembled with an air outlet. The inflator hose is connected with a pressure gauge to show the inflation status. During the inflation process of the tire, the air outlet of the inflator is connected to the tire air valve. Then preset pounds of air are forced into the tire by the air pump of the inflator. When a pressure sensor connected with the pressure gauge detects that the air input into the tire has reached the preset pounds, the air pump stops working and avoids blow-out. However, once the air pump stops, the balance between the tire pressure and the inflator pressure start. Now the pressure sensor connected to the pressure gauge on the inflator detects the value of the pressure balanced. This value is always lower than the preset pressure (pounds per unit area). Even the inflator is initiated again, it stops quickly because instantaneous pressure reaches the preset value immediately. Thus the pressure is not increased effectively. Therefore, according to the method available now, there is a certain gap between the tire pressure and the preset value of the pressure gauge after completion of inflation.

In order to overcome above shortcomings of the inflation method available now, there is a need to improve the method of inflation.

### SUMMARY OF THE INVENTION

Therefore it is a primary object of the present invention to provide an automatic control method of inflation in which a program in a microprocessor is used to process information obtained by a sensor for easy and precise operation of the inflation process.

In order to achieve the above object, the automatic control method of inflation of the present invention uses an inflator to inflate an object and pressure in the object reaches an initial set pressure value. Then an air pump of the inflator is shut down a short period of time until the pressure of the inflated object and the pressure of the inflator are equalized. Next a microprocessor calculates a difference between the initial set pressure value and an actual pressure value after balance. The value of the difference is added with the initial set pressure value so as to get a new set pressure value the object needs to be inflated the next time.

Thereby a value obtained through digital conversion of an electrical signal from a pressure sensor is used for calculation, comparison and judgment of the built-in program when the pressure in the inflator hose reaches the initial set pressure value and the inflation stops temporarily so that the pressure balance can be checked during the shortest time. Not only the accuracy of the measurement of actual pressure value [p_{b}] is increased, the difference for compensation is also obtained, and the interval between the two inflations is shortened.

Moreover, the difference between an actual pressure value [p_{b}] and an initial set pressure value [pₛₑₜ] is calculated and obtained within a short period of time so as to get a compensation value [p_{fix}] is also got. And this compensation value [p_{fix}] is near the initial set pressure value [pₛₑₜ]. Thus the accuracy is quite high by using the difference as the compensation value of the pressure.

Furthermore, the compensation value [p_{fix}] obtained by the program in the microprocessor is used to set a new pressure value [pₙ] as a preset pressure for the next inflation. Then the air pump controlled by the program is turned on again to deliver the air. The whole inflation is automatic, requiring no labors. And the pressure difference is also eliminated for reaching the initial set pressure value [pₛₑₜ].

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of an embodiment according to the present invention;

FIG. 2 is a flow chart of an embodiment according to the present invention.

### DETAILED DESCRIPTION OF THE PREFERRED EMBODIMENT

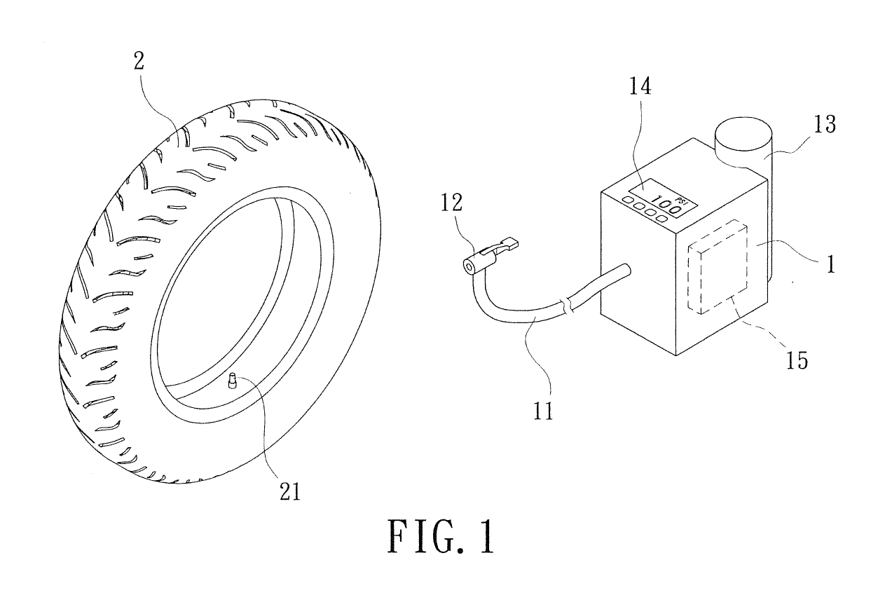

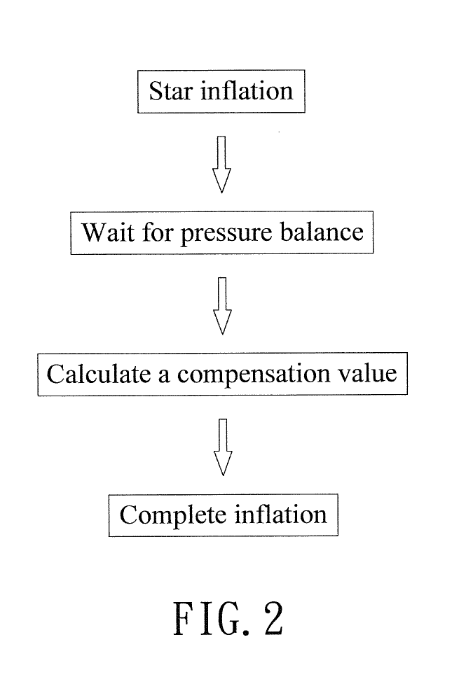

Refer to FIG. 1 and FIG. 2, an automatic control method of inflation includes the following steps.

A. Start inflation: an air outlet 12 assembled with one end of an inflator hose 11 of an inflator 1 is connected to an air valve 21 of an inflated object 2 (the inflated object 2 can be a tire). Then an air pump 13 of the inflator 1 is turned on and preset pounds of air are generated. The air is input into the inflated object 2 through the air outlet 12 of the inflator hose 11. When a pressure sensor in a pressure gauge 14 connected to the inflator hose 11 detects the pressure output from the air pump 13 has already reached an initial set pressure value [pₛₑₜ], it sends a signal back to a microprocessor 15 so that the microprocessor 15 controls and makes the air pump 13 stop inflation.

B. Wait for pressure balance: after short shut-down of the inflator 1, the pressure in the inflated object 2 and the pressure in the inflator hose 11 of the inflator 1 get balanced. The pressure sensor in the pressure gauge 14 immediately detects an actual pressure value [p_{b}] after the balance and displays this value on the pressure gauge 14. At the same time, the actual pressure value [p_{b}] after the balance is transmitted to the microprocessor 15.

C. Calculate a compensation value: according to a built-in program of the microprocessor 15: the initial set pressure value [pₛₑₜ] minus the actual pressure value [p_{b}] after the balance is equal to the compensation value [p_{fix}]. Thus the compensation value [p_{fix}] is calculated and obtained. Then this compensation value [p_{fix}] is added with the initial set pressure value [pₛₑₜ] to get a new set pressure value [pₙ] the inflated object 2 requires.

the compensation value [p_{fix}]=the initial set pressure value [pₛₑₜ]−the actual pressure value [p_{b}] after the balance.

the new set pressure value [pₙ]=the compensation value [p_{fix}]+the initial set pressure value [pₛₑₜ]

D. Complete inflation: according to the new set pressure value [pₙ] obtained, the microprocessor 15 drives the air pump 13 to output air with corresponding pounds weight for finishing the inflation process.

The difference between the preset inflation pressure and the actual pressure of the inflated object 2 can be obtained by the automatic control method of inflation of the present invention after the initial inflation. While performing the next inflation, the value of the preset inflation pressure is added with the difference so as to get a new pressure value of inflation the inflated object 2 actually required. Thus the inflation of the inflated object 2 is completed precisely and the inflation pressure required can be achieved by running two times of inflation procedures. Therefore, not only the inflation time and cost are reduced, the service life of the inflator 1 is prolonged due to less times of inflation.

In summary, the present invention has following advantages:
1. When the pressure in the hose reaches the initial set pressure and the inflator stops working, an electrical signal from the pressure sensor is turned into a value by digital conversion and is used as information for calculation, comparison and judgment of the built-in program so that the pressure balance can be checked during the shortest time. Not only the accuracy of the measurement of actual pressure value [p_{b}] is increased, but the difference value required is also obtained. Moreover, the interval between the two times of inflations is shortened.
2. The difference between the actual pressure value [p_{b}] and the initial set pressure value [pₛₑₜ] is calculated and obtained within a short period of time so as to get the compensation value [p_{fix}]. And the compensation value [p_{fix}] obtained is near the initial set pressure value [pₛₑₜ]. Thus the accuracy is significantly improved by using the difference as the compensation value of the pressure.
3. The compensation value [p_{fix}] obtained by the program in the microprocessor is used to set a new pressure value [pₙ] as a preset pressure for the next inflation. Then the air pump is initiated again by the program to deliver the air. The whole process is automatic, without manual operation. And the pressure difference is also eliminated precisely so as to achieve the initial set pressure value [pₛₑₜ].

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. An automatic control method of inflation comprising the steps of:
A. starting inflation: inflating an inflated object through an inflator hose connecting an inflator and the inflated object until a gauge of the inflator reaches an initial set pressure value and the inflator having a microprocessor; when a pressure sensor in the pressure gauge connected to the inflator hose detects the pressure has reached an initial set pressure value [pₛₑₜ], the pressure sensor sends a signal back to the microprocessor so that the microprocessor controls and makes an air pump stop inflation;
B. waiting for pressure balance: after short shut-down of the inflator, the pressure in the inflated object and the pressure in the inflator hose of the inflator get balanced; the pressure sensor in the pressure gauge immediately detects an actual pressure value [p_{b}] after the balance and sends the actual pressure value [p_{b}] after the balance to the microprocessor.
C. calculating a compensation value: a compensation value [p_{fix}] is calculated and obtained according to a built-in program of the microprocessor: the initial set pressure value [pₛₑₜ] minus the actual pressure value [p_{b}] after the balance is equal to the compensation value [p_{fix}]; then adding this compensation value [p_{fix}] with the initial set pressure value [pₛₑₜ] to get a new set pressure value [pₙ] the inflated object actually needs.
D. completing inflation: the microprocessor drives the air pump to output air with corresponding pounds weight according to the new set pressure value [pₙ] obtained so that the inflation process is completed.
